(19) United States
(12) Patent Application Publication
(10) Pub. No.: US 2010/0080536 A1
(43) Pub. Date: Apr. 1, 2010

(54) INFORMATION RECORDING/REPRODUCING APPARATUS AND VIDEO CAMERA

(75) Inventor: Hiroyuki MARUMORI, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/430,215

(22) Filed: Apr. 27, 2009

(30) Foreign Application Priority Data
Sep. 29, 2008 (JP) 2008-249494

(51) Int. Cl. H04N 5/262; H04N 5/00; G10L 17/00; G06K 9/00

(52) U.S. Cl. 386/102; 386/119; 386/E05.003; 704/246; 704/E17.001; 382/118

(57) ABSTRACT

A video camera which can, without requiring troublesome operations, create a disc having a superimposed dialogue through voice recognition with use of a camera main body alone, and which allows a user to enjoy viewing a video with the superimposed dialogue with use of a general-purpose player. Since such a menu which allows person-by-person display based on face-recognized information is created, a video searching performance is enhanced and thus the user can quickly search for a person appearing in the content.

### INCORPORATION BY REFERENCE

The present application claims priority from Japanese application JP2008-249494 filed on Sep. 29, 2008, the content of which is hereby incorporated by reference into this application.

### BACKGROUND OF THE INVENTION

The present invention relates to a disc recording/reproducing apparatus which includes a plurality of media including BD (Blu-ray Disc) and HDD (Hard Disc Drive).

As one of background arts belonging to the technical field, there is JP-A-2007-027990 as an example. This publication discloses in ‘Abstract’ that “‘problem to be solved’ is to facilitate creation or editing of a balloon or a superimposed dialogue, and ‘Means for Solving Problem’ is to input motion picture data in a face detecting means 103 to detect a face feature and a face position and also to input the data in a voice identifying means 104 to detect a voice feature. The detected features are sent to a speaker identifying means 107 to be compared with speaker's features already stored in a voice/face linkage data memory means 106 and to identify the position of a specific speaker. The identified speaker's voice is converted to a text by a voice recognition means 105. A balloon is created by a balloon creating means 112 with use of the speaker's position and the text data; and the motion picture data, the voice data and the balloon data are combined by a motion picture creating means 114 into new motion picture data.”

As another one of the background arts belonging to this technical field, there is JP-A-2007-266793 as an example. This Publication discloses in ‘Abstract’ that “‘problem to be solved’ is to synthesize display data corresponding to a voice at a suitable position in an image, and ‘Means for Solving Problem’ is to determine whether or not there is a voice in a motion picture reproduction or playback mode (step S325). In the presence of a voice, it is determined whether or not there is at least one mouth (step S326). In the presence of at least one mouth, it is determined whether or not there are a plurality of mouths (step S328). If the determination is NO and only a single mouth is present, then balloon combining operation is executed (step S332). In the presence of a plurality of mouths, it is determined whether or not there is moving one or ones of the mouths (step S329) and it is also determined whether or not there is a single moving mouth (step S330). If there is only a single moving mouth, then balloon combining operation is executed (step 332). The balloon combining operation causes balloon test data as a combination of a balloon with test data given therein to be combined with a background in the vicinity of the mouth determined as being moving.”

### SUMMARY OF THE INVENTION

In a video camera market, in these years, recording media is being shifted from tape to disc in favor of no possibility of inadvertent overwriting and ease of search. Further, a product having not only DVD but also HDD (Hard Disc Drive) or a semiconductor memory as its recording media is also coming along. In these years, further, in order to obtain a large capacity of and a high quality of video picture, a recording apparatus employing a BD (Blue-ray Disc) conforming to next generation optical disc standard determined by the Blu-ray Disc Association (BDA) is coming along. There is also present a hybrid type video camera which employs a combination of HDD and BD to facilitate data transfer or the like. However, as the capacity of a media is increased, many users often leave the recorded media without viewing the contents of photographed videos. Further, a problem will arise that it often takes a lot of time to search for a target video. It is likely that such a trend will continue in the future.

In a digital camera market, on the other hand, such an application program as to have a face recognition function is employed as a new trend. For example, some of such application programs have a function of detecting a face position and performing exposure control and focus control according to the detected face. In these years, an application program having the face recognition function has been employed even in video cameras. For example, there is coming along even such a video camera which has not only the face detection/exposure control and focus control, but also assists photographing (such as advising of panning too fast, too dark to photograph or the like) by image recognition. It will be seen even in such a world of video camera that the recognition technique is becoming a differentiating technique as a trend. In the future, it is estimated that the recognition technique is applied not only to video but also to voice recognition. In fact, in the world of cellular phones, such an application program as to convert a voice to a text is employed. It is also generally practiced that, in TV programs, the conversation of a subject appears as a superimposed dialogue, and it is fun for a user to view it.

As has been explained above, it is expected that the problem associated with the increased capacity of memory often will arise. In order to solve the problem, the point is how to make the user get interested in a photographed video. In other words, if such a video as to cause the user to get interested in the video once again can be created, then the user must pleasantly view the photographed video repeatedly. Even at present, the video can be edited on a personal computer (PC). Nevertheless, the editing is troublesome, and if the user has less experience and knowledge, then it is difficult to edit such a video as to cause the user to want to view it many times.

In view of the above circumstances, the present invention is to propose easy creation of such a video as to cause a user to pleasantly view with use of a camera main body alone. More specifically, when a camera provided with an HDD and a BD as its media is used, the user is encouraged to photograph into the HDD without any special concern during the photographing. When copying the photographed video onto a BD media (with or without retaining the photographed original video), the conversation or voice recorded during the photographing is converted to a text, and a video with a superimposed dialogue is created on the basis of the converted text information. By making the superimposed dialogue conform to the BD standard, the video with the superimposed dialogue can be pleasantly viewed with use of even a general-purpose player. If videos with a superimposed dialog, which is familiar in the case of TV programs, can be easily viewed with use of a camera main body alone, the user can pleasantly enjoy the viewing of the video any time. Further, when combined with the face recognition function, persons appearing in the video can be distinguished. When a menu which is displayed person-by-person for each of the persons involved can be created using the distinguishing information, a searching performance can also be increased upon searching the video.

In accordance with one aspect of the present invention, there is provided an information recording/reproducing apparatus convenient in handling which, for example, creates a disc on which a video with a superimposed dialogue is recorded and also creates a menu which can be displayed for each of the persons based on a face recognition function with use of a camera main body alone, as has been explained above.

In order to implement the above apparatus, such arrangements as set forth in the appending claims are employed.

For example, there is provided an information recording/reproducing apparatus which has a plurality of drive devices corresponding to a plurality of recording media and which performs recording and reproducing operations conforming to the standard of each of the recording media. The information recording/reproducing apparatus includes a face/person recognition device for recognizing a face and a person from a video signal input to the information recording/reproducing apparatus, a voice recognition device for recognizing person's voice from an input voice signal, a recognition controller for managing results recognized by the face/person recognition device and by the voice recognition device, a voice-to-text conversion device for converting spoken words recognized by the voice recognition device to a text, and a copying management device for managing data transfer between the plurality of media. In a copying mode, a superimposed dialogue can be created from voice.

In accordance with the present invention, there is provided an information recording/reproducing apparatus which is convenient in handling. For example, since a disc with a superimposed dialogue can be created based on a voice recognition function with use of a camera main body alone, a user can enjoy viewing a video with the superimposed dialogue with use of a general-purpose player. Since such a menu is created that can be displayed person by person according to face-recognized information, a searching performance for the video can be increased. For this reason, desired one of persons appearing in the contents of the video can be quickly searched.

Other objects, features and advantages of the invention will become apparent from the following description of the embodiments of the invention taken in conjunction with the accompanying drawings.

### BRIEF DESCRIPTION OF THE DRAWINGS

FIG. 1 is an arrangement of a system in accordance with the present invention;

FIG. 2 is a diagram for explaining the operation of the system in a record mode;

FIG. 3 is a diagram for explaining the operation of the system in a dubbing mode;

FIG. 4 shows an example when a content with a superimposed dialogue is reproduced;

FIG. 5 shows a relationship between a source of copying and a destination of copying; and

FIG. 6 shows a menu conforming to a standard.

### DETAILED DESCRIPTION OF THE EMBODIMENTS

A first embodiment of the present invention will be explained with reference to the attached drawings.

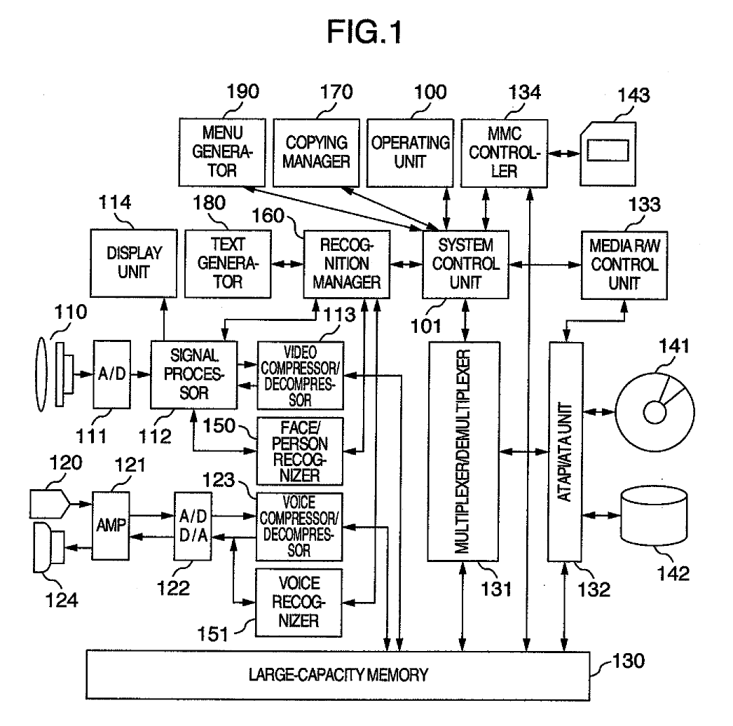

FIG. 1 shows a block diagram of a recording apparatus integrated with a camera. In FIG. 1, reference numeral 100 denotes an operating unit operated by a user, which has keys for recognition including a record/stop key, a zoom key and a key for selection of a recording mode. Reference numeral 101 denotes a system control unit for performing en bloc multiplexing/demultiplexing operation, various types of format control, read/write control over a medium and so on. Reference numeral 110 denotes a CCD or CMOS sensor as a photoelectric conversion means for converting light focused by an optical lens for imaging a subject into an electric signal, numeral 111 denotes an A/D converter for converting a video electric signal to a digital signal, 112 denotes a signal processor for converting image information converted to the digital signal into a video signal, and 113 denotes a video compressor/decompressor for performing compressing/decompressing operation over the video signal according to a predetermined encoding scheme such as MPEG2 or H.264. Reference numeral 114 denotes a display unit for displaying a video, which may be divided into a display part for a finder and a movable display part provided outside of the casing of a video camera. Reference numeral 120 denotes a microphone for converting a collected voice into an electric voice signal; 124 denotes a loudspeaker for generating a voice; 121 denotes an amplifier for amplifying the voice signal; and 122 denotes an A/D converter (or D/A converter) for converting the voice electric signal into a digital signal. Reference numeral 123 denotes a voice compressor/decompressor for performing compressing/decompressing operation over the digital voice according to a predetermined encoding scheme such as Dolby Digital or Mpeg. Numeral 131 denotes a multiplexer for multiplexing a motion picture compressed stream generated by the video compressor/decompressor 113 and a voice compressed stream generated by the voice compressor/decompressor 123. Numeral 130 denotes a large capacity of memory for temporarily storing image data compressed by the video compressor/decompressor 113, voice data compressed by the voice compressor/decompressor 123 and multiplexed data thereof, which memory is used as a buffer. An ATAPI/ATA unit 132 is an interface based on a specific standard, 141 denotes an optical disc such as BD or DVD. Reference numeral 142 denotes a recording media such as HDD (Hard Disc Drive). A media R/W (read/write) control unit 133 performs controlling operation to read/write a data file for a motion image in a predetermined file format to record/reproduce the data file in the optical disc 141 and the recording media 142.

Reference numeral 150 denotes a face/person recognizer for capturing a video signal from the signal processor and recognizing a face or a person, and numeral 151 denotes a voice recognizer for recognizing a voce from PCM data as an input or output of the voice compressor/decompressor 123. Numeral 160 denotes a recognition manager for managing recognition results of the face/person recognizer 150 and the voice recognizer 151, 170 denotes a coping manager for managing coping, 180 denotes a text generator for generating a text, and 190 denotes a menu generator for generating a menu conforming to a standard.

Reference numeral 134 denotes an MMC controller which is used when data is recorded in a media 143 having an MMC interface such as an SD card. A still image as the data is usually recorded, but motion picture data obtained by converting the result of the multiplexer/demultiplexer into a predetermined format may be recorded. In particular, AVCHD recording is carried out.

In this case, the functions of the video compressor/decompressor 113, voice compressor/decompressor 123, multiplexer/demultiplexer 131, face/person recognizer 150, and operating unit 100 are implemented under control of a program by a microprocessor. However, some or all of the functions may be provided in the form of hardware. In FIG. 1, control and information lines are shown as lines at least necessary for explanation, but all the control and information lines are not necessarily illustrated when viewed as a product. In actuality, it can be considered that almost all constituent units are mutually connected.

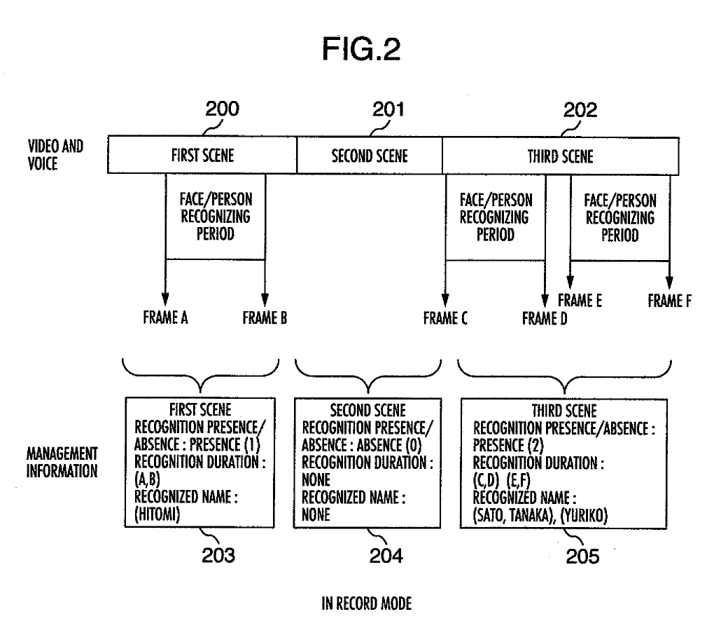

FIG. 2 shows a relationship between a scene and management information when a face or a person is recognized in a record mode. A one-time recording unit is called a scene. Reference numeral 200 denotes a first scene, and numerals 201 and 202 denote second and third scenes respectively. Reference numeral 203 denotes management information acquired through face or person recognition in the first scene. Numerals 204 and 205 denote management information in the second and third scenes respectively. In the illustrated example, one person, who is recorded as a registered name “Hitomi”, is recognized during a time from a frame A to a frame B in the first scene. In the second scene, no face and no person is recognized. In the third scene, there are two locations where faces or persons appear. In one of the two locations, persons named “Sato” and “Tanaka” are recognized; and a person named “Yuriko” is recognized in the other scene.

Explanation will next be made as to the recognizing operation in the record mode by referring to FIGS. 1 and 2.

When a motion picture photographing mode is selected through the operation of the operating unit 100 in FIG. 1, the operating unit 100 recognizes the selection and controls the entire system in such a manner as to be explained below. The CCD or CMOS sensor 110 is driven by a driver (not shown) to a motion picture signal generation mode. An image formed by an optical lens is converted by the CCD or CMOS sensor 110 to an electric signal, converted by the A/D converter 111 to a digital signal, which is then converted by the signal processor 112 to video data, and then compressed by the video compressor/decompressor 113. In the compressing operation, the video data being compressed is sequentially converted to a motion picture compressed stream while the video data is transferred between the memory 130 and the video compressor/decompressor 113. Simultaneously with the compression, a face or a person is detected by the face/person recognizer 150 from an image of the video signal received from the signal processor 112. At this time, the image is one frame unit video but may be resized to a necessary size for recognition. A recognized result is sent to the recognition manager 160 and managed in units of scene. For example, when a face or a person is recognized at a single location in the first scene, the associated management information corresponds to the management information 203 of FIG. 2. Information about whether or not recognition was carried out is managed by “1” (presence) or “0” (absence), video frame information about the first and last frames in the recognized time duration are previously recorded, and when the frame information coincides with a face already registered, the associated name is previously recorded. In the illustrated example, it will be seen that recognition is carried out, the recognition time duration is between the frame A and the frame B (alternatively, time information during streaming may be used), and the recognized face or person is named “Hitomi”. Management information 204 is for the second scene. In the second scene, no face nor person is recognized and hence all the management information is indicated as none. Management information 205 is for the third scene. In the third scene, there are two locations where recognized face or person appears. In one of the two locations, persons named “Sato” and “Tanaka” are recognized during a time from a frame C to a frame D. In the other scene, only a person named “Yuriko” is recognized during a time from a frame E to a frame F. Such management information as shown in FIG. 2 is previously recorded in the record mode.

A voice collected by the microphone 120, on the other hand, is passed through the amplifier 121 and the A/D (or D/A) converter 122, compressed by the voice compressor/decompressor 123, and then temporarily stored in the memory 130. Thereafter, a motion picture compressed stream generated by the video compressor/decompressor 113 and a voice compressed stream generated by the voice compressor/decompressor 123 which have been stored in the memory 130 are multiplexed by the multiplexer/demultiplexer 131, and the multiplexed data is temporarily stored in the memory 130. At this time, the format controller makes a format conforming to the standard. The multiplexed data is eventually output from the memory 130, and recorded through the media R/W control unit 133 and the ATAPI/ATA unit 132 in the optical disc 141 and the recording media 142 in a predetermined recording format. In the present embodiment, the data is recorded in the HDD.

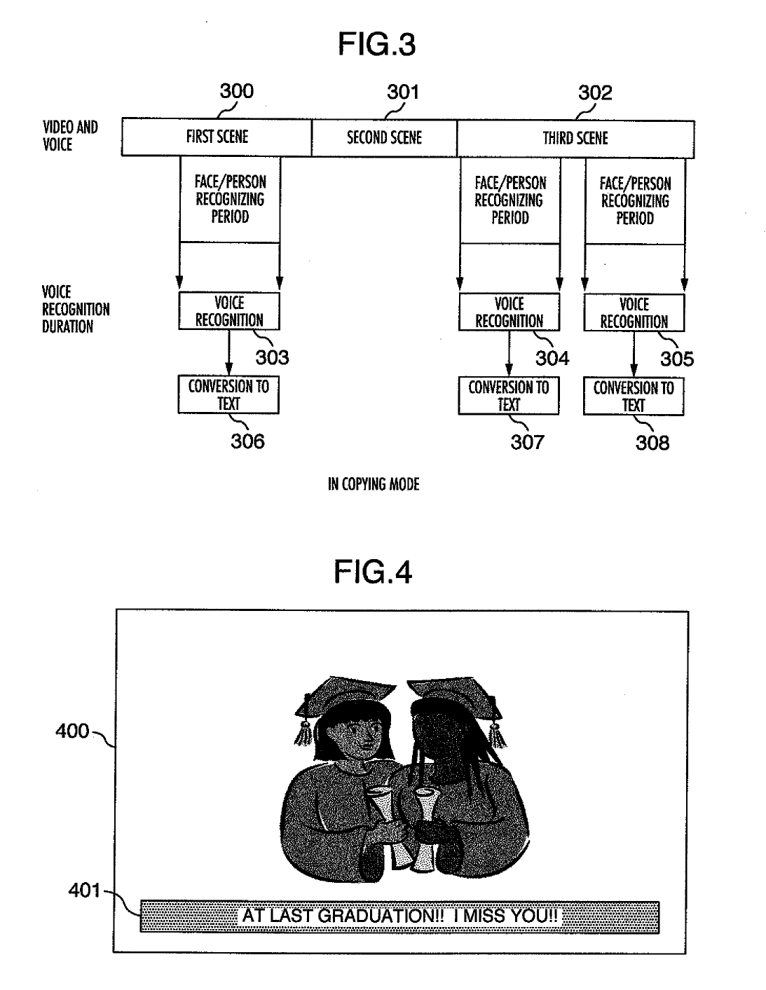

Explanation will then be made as to the operation of creating a disc having a superimposed dialogue added in a copying mode on the basis of management information in a record mode, by referring to FIGS. 1 and 3.

FIG. 3 is a diagram for explaining the operation when a voice is converted to a text in the copying mode. Reference numeral 300 denotes a first scene, and numerals 301 and 302 denote second and third scenes, respectively. Reference numeral 303 denotes a voice recognition time duration in the first scene, during which voice recognition is carried out during a time acquired by face and person recognition, and the recognized voice result is converted to a text. Reference numerals 304 and 305 denote voice recognition time durations in the second and third scenes, during which voice recognition and text conversion are carried out respectively.

Copying is a function of copying a content on the HDD to an optical disc or an SD card or of moving the content thereto. More specifically, copying is achieved by once reading out data on the HDD, demultiplexing it to a video and a voice, and thereafter again compressing and multiplexing it in a format conforming to the format of the copying destination. Voice recognition is carried out at the timing of decompressing the demultiplexed data, the voice is converted to a text, and the resulted text is multiplexed on the video and the voice in a remultiplexing mode. Multiplexing means to convert data added with information about a reproduction time into a packet or packets. Take for example the BD, by making this multiplexing method conform to the Standard of the Blue-ray Disc Association (BDA), a superimposed dialogue can be displayed with use of a general-purpose player. Therefore, it is indispensable to make the multiplexing method conform to the associated standard. For example, in the case of DVD or SD card, its recording is required to conform to the standard such as AVCHD. If there is a leeway in the system performance, then voice recognition may be carried out simultaneously with acquisition of the management information in the record mode.

Explanation will be made as to the specific operation of copying data from the recording media 142 to the optical disc 141, with reference to FIGS. 1 and 3. When receiving a copying instruction from the operating unit 100 in FIG. 1, the system control unit 101 informs the copying manager 170 of the type of a disc to be recorded. The instruction may be obtained not only from the operating unit but also from a pull-down menu. When the copying destination is BD, the copying manager 170 prepares for multiplexing (prepares for a necessary library or the like) so as to conform to the standard of the BD. Thereafter, a content is sent from the HDD 142 via the ATAPI/ATA unit 132 to the multiplexer/demultiplexer 131 under control of an instruction of the media R/W control unit 133. In this case, a video and a voice are once separated in the multiplexer/demultiplexer, but separated information is once stored in the large capacity memory. If it is desired to convert the rates of the video and the voice, the video and the voice may be once re-compressed by the video compressor/decompressor 113 and by the voice compressor/decompressor 123 to necessary rates. In this case, the system control unit 101 refers to the management information created by the recognition manager 160 in the record mode and obtains information about which ones of the frames in the scene contain a face or a person. For example, the voice recognition time duration 303 in FIG. 3 corresponds to such frame part. While this frame part is being demultiplexed, the voice compressed stream demultiplexed by the multiplexer/demultiplexer 131 is converted by the voice compressor/decompressor to PCM data (non-compressed data) via the large-capacity memory. The converted PCM data is voice-recognized by the voice recognizer 151 to recognize the speaker's conversation. The recognized information is once managed by the recognition manager 160 and thereafter converted by the text generator 180 to a text corresponding to the speaker's conversation. In this case, if the voice recognizer fails to recognize some words in the conversation data, such words may be excluded from voice recognition. Thereafter, the multiplexer/demultiplexer converts the text words into a superimposed dialogue and multiplexes it with the video and the voice. In the case of BD, the voice and video are multiplexed in the form of TS (transport stream) and a superimposed dialogue is multiplexed in the form of a presentation graphic (PG) stream. Similarly, text conversion time durations 307 and 308 are generated for the voice recognition time durations 304 and 305 in FIG. 3, and are used in the re-multiplexing operation. Even in the case of DVD, this can cope with it by generating a superimposed dialogue conforming to the DVD standard.

Next shown in FIG. 4 is the disc effect of a generated superimposed dialogue. FIG. 4 shows an example when a superimposed dialogue is being reproduced. Reference numeral 400 denotes a display screen when a video is played back with use of a general-purpose player, and numeral 401 denotes a superimposed dialogue displayed when the superimposed dialogue playback function of the player is activated.

As shown in FIG. 4, so long as the general-purpose player conforms to the standard, the superimposed dialogue can be confirmed by activating the superimposed dialogue playback function of the player. It will be seen that this is assumed that the management information 205 have two persons (“Sato” and “Tanaka”) and their conversation is given as the superimposed dialogue. Although timing is not specifically explained here, the timing between the conversation and the superimposed dialogue may be strictly managed by also applying a lip-synching.

As mentioned above, voice analysis and text conversion are carried out on the basis of management information generated during recording operation in a desired time duration, re-multiplexing operation is carried out with use of the text information as a superimposed dialogue, whereby a pleasant disc with the superimposed dialogue can be created with use of a general-purpose player. Since the conversation is changed to a superimposed dialogue, it is fun to view it.

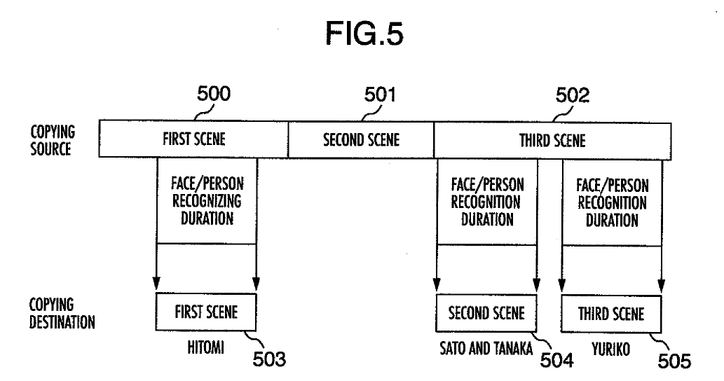

A second embodiment of the present invention will be explained by referring to FIGS. 1, 5 and 6. FIG. 5 shows a relationship between a copying source and a copying destination when a menu is generated according to face and person. Reference numeral 500 denotes a first scene at the copying source. Numerals 501 and 502 denote second and third scenes, respectively, of the recording source. Numeral 503 denotes first scene as the copying destination where a person “Hitomi” appears. Similarly, reference numerals 504 and 505 denote a second scene where persons “Sato” and “Tanaka” appear and a third scene where a person “Yuriko” appears, as copying destinations.

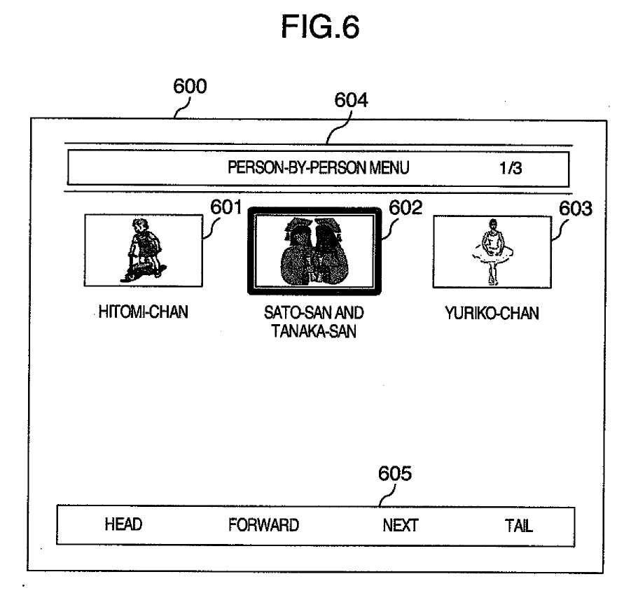

FIG. 6 shows a display screen on which a menu conforming to the standards of BD and DVD is displayed. This menu can be displayed with use of a general-purpose player since the menu conforms to the standards. Reference numeral 600 denotes an entire menu, numeral 601 denotes a thumbnail for the first scene 503 in FIG. 5. Similarly, numerals 602 and 603 denote thumbnails for the second and third scenes 504 and 505, respectively, of FIG. 5. Numeral 605 denotes menu commands.

When an instruction of menu generation is issued from the operating unit 100 in FIG. 1, the system control unit 101 instructs the menu generator 190 to prepare necessary thumbnail, background and so forth, and menu data is sequentially recorded in a disc while the necessary data are multiplexed by the multiplexer/demultiplexer according to the standard.

In a general menu, a thumbnail is displayed for each of photographed scenes. In this embodiment, however, it is possible to generate a menu for a collection of not only the aforementioned scene thumbnails but also a collection of face or person appearing scenes. More specifically, the first, second and third scenes 503, 504 and 505 having one person or persons appear therein as in FIG. 5 are recognized as new scenes. For example, the face/person appearing parts are divided and extracted from the first scene 500 as the copying source on the basis of the management information in the record mode. Similarly, the second and third scenes 504 and 505 are prepared. The new scenes are copied as in the first embodiment. In this case, a superimposed dialogue may or may not be provided. Thereafter, when a menu conforming to the standard is generated for the new scenes of the copying destinations, a menu having only a collection of persons or faces can be generated.

How to generate a menu conforming to the standard is not specifically mentioned. However, since the menu generation method is eventually only required to conform to the standard, the menu generation method is not limited to a specific method.

FIG. 6 shows a result of generation by implementing the method above. An illustrated title (passage) of each thumbnail given under the thumbnail in FIG. 6 can be created by arbitrary method. In the illustrated example of FIG. 6, “-chan” (Japanese expression like “-o” in “daddy-o” in English expression) or “-san” (Japanese expression similar to “-o” but more formal) are added to the person's name when creating the menu.

Since a menu having a collection of face and person appearing scene parts can be generated as has been explained above, the user can quickly find a target subject with use of a general-purpose player.

It should be further understood by those skilled in the art that although the foregoing description has been made on embodiments of the invention, the invention is not limited thereto and various changes and modifications may be made without departing from the spirit of the invention and the scope of the appended claims.

1. An information recording/reproducing apparatus having a plurality of drive devices corresponding to a plurality of recording media for performing recording/reproducing operation according to standards of the recording media, comprising;
a face/person recognition device for recognizing a face or a person from a video signal input to the information recording/reproducing apparatus;
a voice recognition device for recognizing person's voice from an input voice signal;
a recognition manager for managing recognized results from the face/person recognition device and by the voice recognition device;
a voice/text conversion device for converting a voice recognized by the voice recognition device into a text; and
a copying management device for managing data transfer between the plurality of media,
wherein a superimposed dialogue is generated from the voice in a copying mode.

2. An information recording/reproducing apparatus according to claim 1, wherein the plurality of recording media are arbitrary ones of BD, DVD, HDD and SD card, and in the case of the SD card and the DVD, data are recorded in a format of the AVCHD standard.

3. An information recording/reproducing apparatus according to claim 2, wherein information about a position or a size recognized by the face/person recognition device in a record mode is managed by said recognition manager for each record.

4. An information recording/reproducing apparatus according to claim 3, wherein the face/person recognition device has a function of determining even a previously-recorded face, and information to be managed by the recognition manager is identifiable information including presence or absence of a face in a photographed scene, a time during which the face is recorded, and previously registered person name.

5. An information recording/reproducing apparatus according to claim 4, wherein a voice is recognized by the voice recognition device while a video of a copying source is reproduced, and the recognized voice is converted by the voice/text conversion device into a text.

6. An information recording/reproducing apparatus according to claim 5, wherein, when the copying management device performs its copying operation, the converted text data is multiplexed in a format conforming to a standard.

7. An information recording/reproducing apparatus according to claim 6, wherein a part of a video managed by the recognition manager and corresponding to a period during which the face is recoded is made a new scene or is divided into independent scenes.

8. An information recording/reproducing apparatus according to claim 7, wherein only the independent scenes are copied by the copying management device.

9. An information recording/reproducing apparatus according to claim 8, wherein, after the independent scenes are copied by the dubbing management device, the previously registered person name managed by the recognition manager is added to a menu.

10. A video camera having a plurality of drive devices corresponding to BD, DVD, HDD (Hard Disc Drive), and SD card for performing recording/reproducing operation according to standards thereof,
wherein, when data is recorded in the HDD, a face or person recognized position or a duration thereof is previously held as management information, data converted to a text by voice-analyzing a video part having a face or a person present therein from the held management information is multiplexed and copied in the BD, DVD or SD card, thereby creating a disc having a superimposed dialogue capable of being reproduced by a general-purpose player.

11. A video camera comprising:
photographing means for photographing a subject to generate a video signal;
voice collecting means for collecting a voice to generate a voice signal;
first recording/reproducing means for recording/reproducing the video signal and the voice signal in/from a first recording media;
second recording/reproducing means for recording/reproducing the video signal and the voice signal in/from a second recording media;
recognition means for recognizing a specific subject from the video signal;
conversion means for converting a voice in the voice signal corresponding to the specific subject recognized by the recognition means into a text; and
control means for controlling the first and second recording/reproducing means, the recognition means and the conversion means to reproduce the video signal and the voice signal from the first recording media and to record the text converted by the conversion means together with the reproduced video signal and voice signal in the second recording media.

12. An information recording/reproducing apparatus according to claim 1, wherein information about a position or a size recognized by the face/person recognition device in a record mode is managed by said recognition manager for each record.

13. An information recording/reproducing apparatus according to claim 12, wherein the face/person recognition device has a function of determining even a previously-recorded face, and information to be managed by the recognition manager is identifiable information including presence or absence of a face in a photographed scene, a time during which the face is recorded, and previously registered person name.

14. An information recording/reproducing apparatus according to claim 13, wherein a voice is recognized by the voice recognition device while a video of a copying source is reproduced, and the recognized voice is converted by the voice/text conversion device into a text.

15. An information recording/reproducing apparatus according to claim 14, wherein, when the copying management device performs its copying operation, the converted text data is multiplexed in a format conforming to a standard.

16. An information recording/reproducing apparatus according to claim 15, wherein a part of a video managed by the recognition manager and corresponding to a period during which the face is recoded is made a new scene or is divided into independent scenes.

17. An information recording/reproducing apparatus according to claim 16, wherein only the independent scenes are copied by the copying management device.

18. An information recording/reproducing apparatus according to claim 17, wherein, after the independent scenes are copied by the dubbing management device, the previously registered person name managed by the recognition manager is added to a menu.
